(19) United States
(12) Patent Application Publication
(10) Pub. No.: US 2007/0079686 A1
(43) Pub. Date: Apr. 12, 2007

(54) Snare-adjusting device for a snare drum

(76) Inventor: Wu-Hong Hsieh, Lu Chou City (TW)

Correspondence Address: BACON & THOMAS, PLLC, 625 SLATERS LANE, FOURTH FLOOR, ALEXANDRIA, VA, 22314, US

(21) Appl. No.: 11/247,170

(22) Filed: Oct. 12, 2005

(51) Int. Cl. G10D 13/02

(52) U.S. Cl. 84/415

(57) ABSTRACT

A snare-adjusting device for adjusting a tension of a snare on a snare drum has a drum mount, a slide assembly and a tone lever assembly. The drum mount is mounted the snare drum and has a slide cavity, an opening and multiple blind holes. The slide assembly is mounted in the drum mount and has a slider and a snare fastener. The slider is mounted slidably in the slide cavity and has an inclined slot. The snare fastener is mounted to the slider and holds the snare. The tone lever assembly is mounted pivotally on the drum mount and has a tone lever, a sliding member and an alignment member. The sliding member is mounted slidably the inclined slot in the slider. The alignment member detachably engages one of the blind holes. Pivoting the tone lever to align with different blind holes easily changes the tone of the snare.

### BACKGROUND OF THE INVENTION

1. Field of the Invention

The present invention relates to an adjusting device for a drum, and more particularly to a snare-adjusting device that is mounted on a snare drum and can quickly change the tension of a snare on the snare drum in multiple stages.

2. Description of Related Art

Snare drums are common percussion instruments always shown in musical bands.

A conventional snare drum has a hollow body, two brackets and a snare. The hollow body has an annular sidewall, a bottom and a top. The brackets are mounted on the sidewall opposite to each other. The snare is attached to the brackets, eliminates the repercussion from the body when the snare drum is played and has two ends. The ends are respectively mounted to the brackets by screwing bolts through the ends in the brackets. However, the bolts may be loosen by the vibration when the snare drum is played and cause the slack of the snare.

Furthermore, the timbre of the snare drum depends on the tension of the snare. To change the tension of the snare, the bolts on the brackets are detached during the period of adjusting the tension of the snare and are reattached when the adjustment is complete. Therefore, the adjustment of the snare by detaching and attaching the bolts is complicated and wastes time.

To overcome the shortcomings, the present invention provides a snare-adjusting device for a snare drum to mitigate or obviate the aforementioned problems.

### SUMMARY OF THE INVENTION

The main objective of the invention is to provide a snare-adjusting device that is mounted on a snare drum and can quickly change the tension of a snare on the snare drum in multiple stages.

A snare-adjusting device for adjusting a tension of a snare on a snare drum in accordance with the present invention comprises a drum mount, a slide assembly and a tone lever assembly.

The drum mount is mounted on the snare drum and has a slide cavity, an opening and multiple blind holes.

The slide assembly is mounted in the drum mount and has a slider and a snare fastener. The slider is mounted slidably in the slide cavity and has an inclined slot. The snare fastener is attached to the slider and holds the snare.

The tone lever assembly is mounted pivotally on the drum mount and has a tone lever, a sliding member and an alignment member. The sliding member is mounted slidably in the inclined slot in the slider. The alignment member detachably engages one of the blind holes.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a snare-adjusting device for a snare drum in accordance with the present invention;

FIG. 2 is an exploded perspective view of the snare-adjusting device in FIG. 1;

FIG. 3 is a rear view in partial cross section of the snare-adjusting device in FIG. 1;

FIG. 4 is an enlarged cross-sectional side view of the snare-adjusting device in FIG. 1;

FIG. 5 is a perspective view of a snare drum with the snare-adjusting device in FIG. 1 and connected to a snare on the snare drum;

FIG. 6 is a rear view of the snare-adjusting device in FIG. 5; and

FIG. 7 is an operational rear view of the snare-adjusting device in FIG. 6.

### DETAILED DESCRIPTION OF PREFERRED EMBODIMENT

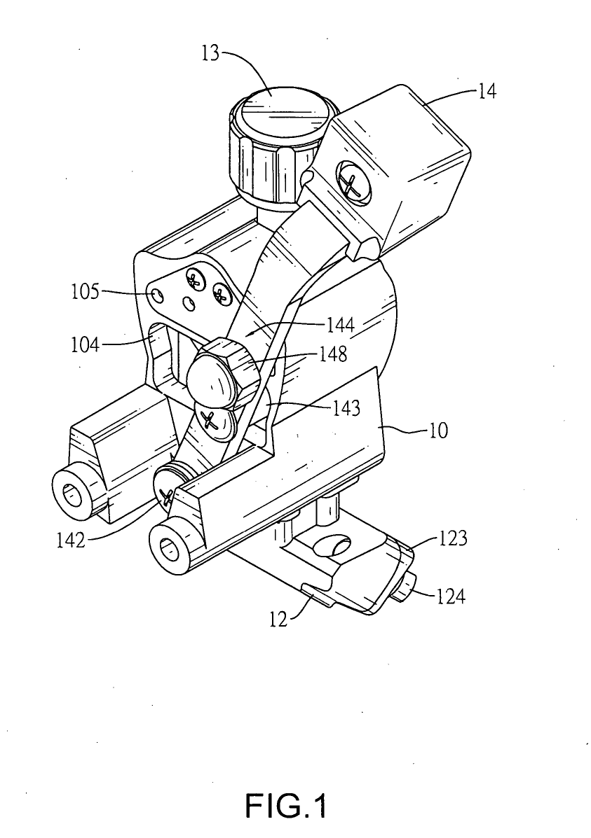

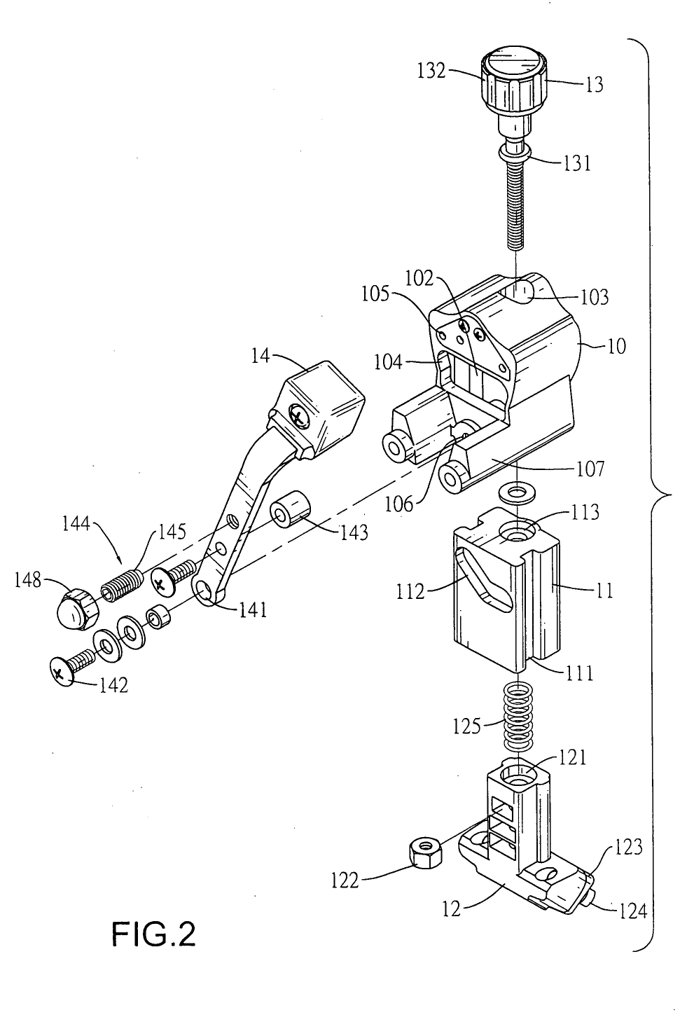

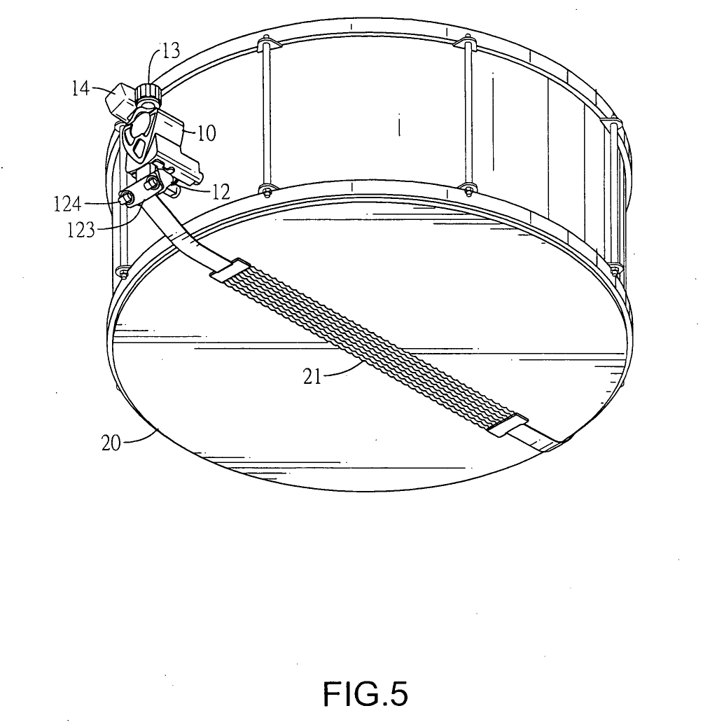

With reference to FIGS. 1, 2 and 5, a snare-adjusting device in accordance with the present invention is mounted on a snare drum (20). The snare drum (20) has a body, a bracket and a snare (21). The body has an annular sidewall and a bottom. The bracket is mounted on the annular sidewall. The snare (21) is mounted on the bottom and has two ends and two straps. The straps are attached to the ends of the snare (21). One of the straps is attached securely to the bracket and the other strap is attached adjustably to the snare-adjusting device.

The snare-adjusting device is mounted on the annular sidewall of the body and comprises a drum mount (10), a slide assembly and a tone lever assembly.

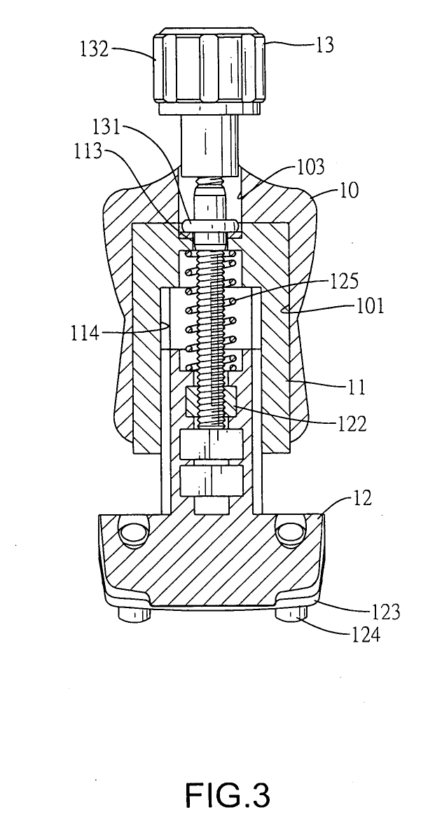

With further reference to FIG. 3, the drum mount (10) is hollow, is attached to the annular sidewall of the body of the snare drum and has a top, a bottom, a rear, a slide cavity (101), at least one optional track (102), a mounting hole (103), an opening (104), multiple blind holes (105) and two connectors (107).

The slide cavity (101) is defined in the bottom of the drum mount (10) and has an inner surface.

The at least one track (102) is formed on the inner surface of the slide cavity (101).

The mounting hole (103) is defined through the top of the drum mount (10) and communicates with the slide cavity (101).

The opening (104) is defined in the rear of the drum mount (10) and communicates with the slide cavity (101).

The blind holes (105) are defined in the rear of the drum mount (10) at intervals.

The connectors (17) extend from the rear of the drum mount (10) at an interval and are connected to the annular sidewall of the body of the snare drum (20).

The slide assembly is mounted in the drum mount (10) and has a slider (11), a snare fastener (12) and a fastening blot (13).

The slider (11) is mounted slidably in the slide cavity (101) in the drum mount (10) and has a top, a bottom, a rear, an outer surface, a fastener cavity (114), an inclined slot (112), a mounting hole (113) and at least one optional groove (11 1). The fastener cavity (114) is defined in the bottom of the slider (11) and has an inner surface. The inclined slot (112) is defined in the rear of the slider (11), communicates with the fastener cavity (114) and is aligned with the opening (104) in the drum mount (10). The mounting hole (113) is defined through the top of the slider (11) and communicates with the fastener cavity (114). The at least one groove (111) is defined in slider (11) and slidably engages with the at least one track (102) in the slide cavity (101) in the drum mount (10).

The snare fastener (12) is mounted slidably in the fastener cavity (114) in the slider (11), holds a corresponding one of the straps on the snare (21) and has a top end, a bottom end, a mounting hole (121), a nut (122), a clipping tab (123), multiple screws (124) and a spring (125). The mounting hole (121) is defined in the top end of the snare fastener (12) and has an inner surface. The nut (122) is mounted securely in the mounting hole (121). The clipping tab (123) is mounted on the bottom end of the snare fastener (12) and cooperates with the bottom of the snare fastener (12) to clip a corresponding strap on the snare (21). The screws (124) extend through the clipping tab (123) and are screwed into the bottom of the snare fastener (12) and may be adjusted to fix or release the strap on the snare (21). The spring (125) is mounted in the mounting hole (121) in the snare fastener (125) and has two ends. One of the ends of the spring (125) abuts the inner surface of the fastener cavity (114) in the slider (11) and the other end abuts the inner surface of the mounting hole (121) in the snare fastener (12)

The fastening bolt (13) extends through the mounting hole (103) in the drum mount (10), the mounting hole (113) in the slider (11) and the spring (125) and is screwed through the nut (122) in the mounting hole (121) in the snare fastener (12). The fastening bolt (13) has a top end, an annular outer flange (131) and a knob (132). The annular outer flange (131) extends radially out from the fastening bolt (13) near the top end, abuts the outer surface of the slider (11) and cooperates with the spring (125) in the fastener (12) to prevent the slider (11) from arbitrarily moving relative to the fastening bolt (13). The knob (132) is formed on the top of the fastening bolt (13). Rotating the knob (132) causes the fastener (12) to move along the fastening bolt (13) and extend out of or into the fastener cavity (114) in the slider (11).

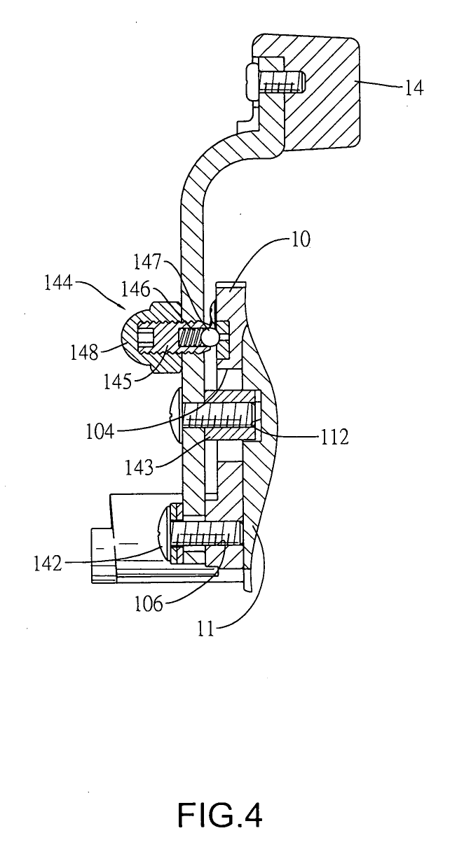

With reference to FIG. 4, the tone lever assembly is mounted pivotally on the drum mount (10) and has a tone lever (14), a sliding member (143) and an alignment member (144).

The tone lever (14) is mounted pivotally on the rear of the drum mount (10) between the connectors (107), may be pivoted to change the tension of the snare (21) and the tone of the snare drum (20). The tone lever (14) has a proximal end, a distal end, a pivot (142) and an optional enlarged head. The pivot (142) is mounted through the proximal end and is mounted in the rear of the drum mount (10) and may be a screw screwed in the rear. The enlarged head is attached to the distal end of the tone lever (14).

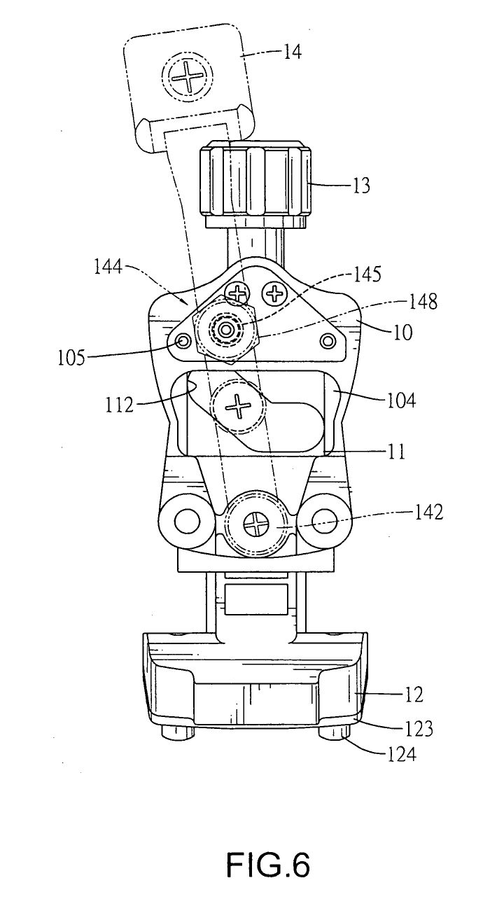

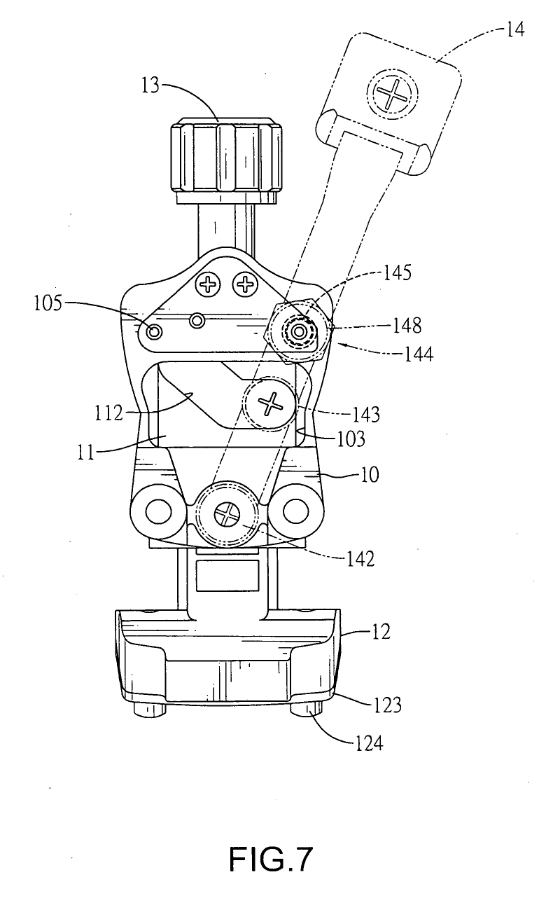

With reference to FIGS. 6 and 7, the sliding member (143) is mounted on the tone lever (14) and is mounted slidably the inclined slot (112) in the slider (11). Pivoting the tone lever (14) causes the sliding member (143) to slide in the inclined slot (123) and causes the slide assembly to move up or down in the drum mount (10). The snare (21) is tightened or released when the slider (11) moves up or down so the tension of the snare (21) relative to the tone of the snare drum can be changed.

The alignment member (144) is mounted to the tone lever (14), detachably engages one of the blind holes (105) to hold the tone lever assembly in a predicted position and has a mounting bolt (145), a spring (146) and a ball (147). The mounting bolt (145) is mounted through the tone lever (14) and has an enlarged head (148) and a central hole. The spring (146) is mounted in the central hole in the mounting bolt (145). The ball (147) is mounted retractably in the central hole, is pressed against the spring (146) to extend partially out of the central hole and engages one of the blind holes (105) in the drum mount (10).

With the alignment member (144) and the blind holes (105) in the drum mount (10), the tone lever assembly can be easily held in different stages corresponding to different tones of the snare drum. In other words, the tone of the snare drum can be changed quickly and simply without detaching and re-attaching any element on the snare-adjusting device.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A snare-adjusting device for adjusting a tension of a snare on a snare drum comprising:
a drum mount adapted to be mounted the snare drum and having a top, a bottom, a rear, a slide cavity defined in the bottom of the drum mount and having an inner surface, an opening defined in the rear of the drum mount and communicating with the slide cavity, and multiple blind holes defined in the rear of the drum mount at intervals;
a slide assembly mounted in the drum mount and having
a slider mounted slidably in the slide cavity in the drum mount and having a top, a bottom, a rear, an outer surface, an inclined slot defined in the rear of the slider and aligned with the opening in the drum mount; and
a snare fastener attached to the slider and adapted to hold the snare; and
a tone lever assembly mounted pivotally on the drum mount and having
a tone lever mounted pivotally on the rear of the drum mount and having a proximal end, a distal end and a pivot mounted through the proximal end and mounted in the rear of the drum mount;
a sliding member mounted on the tone lever and mounted slidably in the inclined slot in the slider; and
an alignment member mounted to the tone lever and detachably engaging one of the blind holes to hold the tone lever assembly.

2. The snare-adjusting device as claimed in claim 1, wherein:
the drum mount further has a mounting hole defined through the top of the drum mount and communicating with the slide cavity;
the slider further has a fastener cavity defined in the bottom of the slider and communicating with the inclined slot and a mounting hole defined through the top of the slider and communicating with the fastener cavity;
the snare fastener is mounted slidably in the fastener cavity in the slider and has
a top end;
a bottom end;
a mounting hole defined in the top end of the snare fastener and having an inner surface;
a nut mounted securely in the mounting hole in the snare fastener; and
a spring mounted in the mounting hole in the snare fastener, having two ends, and one of the ends of the spring abutting the inner surface of the fastener cavity in the slider and the other end abutting the inner surface of the mounting hole in the snare fastener;
the slide assembly further has a fastening bolt extending through the mounting hole in the drum mount, the mounting hole in the slider and the spring, screwed through the nut in the mounting hole in the snare fastener and having a top end and an annular outer flange, wherein the annular outer flange extends radially out from the fastening bolt near the top end, abuts the outer surface of the slider and cooperates with the spring in the fastener to prevent the slider from arbitrarily moving relative to the fastening bolt.

3. The snare-adjusting device as claimed in claim 1, wherein the alignment member of the tone lever assembly has
a mounting bolt mounted through the tone lever and having an enlarged head and a central hole;
a spring mounted in the central hole in the mounting bolt; and
a ball mounted retractably in the central hole, pressed against the spring to extend partially out of the central hole and engaging one of the blind holes in the drum mount.

4. The snare-adjusting device as claimed in claim 2, wherein the alignment member of the tone lever assembly has
a mounting bolt mounted through the tone lever and having an enlarged head and a central hole;
a spring mounted in the central hole in the mounting bolt; and
a ball mounted retractably in the central hole, pressed against the spring to extend partially out of the central hole and engaging one of the blind holes in the drum mount.

5. The snare-adjusting device as claimed in claim 1, wherein:
the drum mount further has two connectors extending from the rear of the drum mount at an interval and adapted to be connected to the snare drum; and
the tone lever assembly is located between the connectors.

6. The snare-adjusting device as claimed in claim 2, wherein the snare fastener further has
a clipping tab attached to the bottom end of the snare fastener and cooperating with the bottom of the snare fastener to be adapted to clip the snare; and
multiple screws extending through the clipping tab and mounted in the bottom of the snare fastener.

7. The snare-adjusting device as claimed in claim 2, wherein the fastening bolt further has a knob formed on the top end of the fastening bolt.
